(19) United States
(12) Patent Application Publication
(10) Pub. No.: US 2010/0247720 A1
(43) Pub. Date: Sep. 30, 2010

(54) Method of Cooking Frozen Meat

(75) Inventors: Steven D. Leitch, Willmar, MN (US); Becky S. Brown, Willmar, MN (US)

Correspondence Address: IPLM GROUP, P.A., POST OFFICE BOX 18455, MINNEAPOLIS, MN, 55418, US

(73) Assignee: Jennie-O Turkey Store, LLC

(21) Appl. No.: 12/772,273

(22) Filed: May 3, 2010

Related U.S. Application Data
(62) Division of application No. 11/601,545, filed on Nov. 17, 2006.
Application No. 11/601,545 is a division of application No. 10/975,242, filed on Oct. 28, 2004, now abandoned.

(51) Int. Cl. A23L 1/315; A23L 1/01

(52) U.S. Cl. 426/234; 426/412

(57) ABSTRACT

A preferred embodiment method of cooking a frozen bird includes cooking the frozen bird in a bag, which creates a steam environment to evenly and thoroughly cook the bird in a reasonable amount of time.

This invention claims priority to and is a divisional application of U.S. patent application Ser. No. 11/601,545, filed Nov. 17, 2006, entitled “Packaging and Frozen Meat Combination”, which is a divisional of U.S. patent application Ser. No. 10/975,242, filed Oct. 28, 2004, entitled “Method of Cooking a Frozen Turkey”; which are hereby incorporated by reference.

### BACKGROUND OF THE INVENTION

1. Field of the Invention

The present invention relates to a packaging and frozen meat combination.

2. Description of the Prior Art

Turkey meat may be vacuum packaged and sealed to provide a consumer-friendly packaging and to extend the shelf-life of the meat. Turkey meat may also be frozen to extend the shelf-life of the meat. Typically, the frozen turkey meat is defrosted and removed from the packaging prior to cooking to ensure even, thorough cooking of the turkey meat, especially if a whole turkey is being cooked. If the turkey meat is still frozen, even partially, uneven cooking of the turkey meat typically occurs. It may take several hours to adequately defrost a whole turkey. Improperly defrosted turkey meat can increase the risk of spoilage of the meat. In addition, the quality of the meat may be reduced by improperly defrosting the turkey meat such as by increasing purge or by degrading the protein. Therefore, it is desired to provide a packaging and frozen meat combination for cooking the frozen meat such as a frozen, whole turkey resulting in a satisfactory end product.

### SUMMARY OF THE INVENTION

In one aspect of the present invention, a packaging and a frozen meat combination includes a frozen meat and a heat resistant bag. The frozen meat is selected from the group consisting of a frozen whole turkey, a frozen split bird, a frozen breast, a frozen breast roast, a frozen pork roast, and a frozen beef roast. The frozen meat has a top, sides, and a bottom. The heat resistant bag has a cavity in which the frozen meat is contained, and the heat resistant bag is oversized relative to the frozen meat and allows space to be created between the heat resistant bag and the top and the sides of the frozen meat. The space is at least 1.50 inches.

In another aspect of the present invention, a packaging and a frozen whole turkey combination includes a frozen whole turkey and a heat resistant bag. The frozen whole turkey has a top, sides, and a bottom. The heat resistant bag has a cavity in which the frozen whole turkey is contained, and the heat resistant bag is oversized relative to the frozen whole turkey to allow for at least 1.50 inches of space between the heat resistant bag and the top and the sides of the frozen whole turkey.

### BRIEF DESCRIPTION OF THE DRAWINGS

FIG. 1 is a perspective view of a turkey in a bag constructed according to the principles of the present invention;

FIG. 2 is a side view of the turkey in the bag shown in FIG. 1; and

FIG. 3 is a top view of the turkey in the bag shown in FIG. 1.

### DETAILED DESCRIPTION OF A PREFERRED EMBODIMENT

A preferred embodiment of the present invention is a method of cooking a frozen whole turkey. The frozen whole turkey is preferably cooked in a bag resulting in evenly, thoroughly cooked turkey meat. Although the present invention is discussed with respect to a frozen whole turkey, it is recognized that other suitable types of meat such as, but not limited to, a frozen split bird (one leg, 1 wing, and ½ breast), a frozen pork roast, or a frozen beef roast could also be used. Therefore, the term “frozen whole turkey” may be interchanged with other suitable types of meat. Further, the more general term “bird” is used throughout to refer to the frozen whole turkey used in the preferred embodiment and may also be interchanged with other suitable types of meat.

The bag is oversized relative to the size of the bird, and the bag is not shrunk to fit the size of the bird. If the bag is too tight around the bird, the portions of the bird where the bag contacts the bird will be over-cooked and may burn. However, the bottom of the bag where the cooked-out juices collect and the bird sits in the collected juices will not over-cook and burn. Typically, there will be approximately at least 2 to 4 cups of cooked-out juices that collect at the bottom of the bag and there will be approximately 1.5 inches of juices at the bottom of the bag. Except for the bottom of the bag where the cooked-out juices collect, there should be a sufficient amount of space between the bag and the bird so that direct contact between the bag and the bird does not occur. Preferably, except for proximate the bottom of the bird, there is approximately at least 1.50 inches of space between the bag and the top and the sides of the bird.

Depending upon the size of the bird, the bird is placed within an appropriately sized bag, the bag is configured and arranged to allow preferably approximately at least 1.50 inches between the bag and the top and the sides of the bird. A vacuum is drawn in the bag, and the open end of the bag is sealed using a clip, a heat seal, or other suitable sealing means well known in the art. Typically, approximately 20 to 23 inches Hg vacuum is used to pull the bag relatively tight around the bird before the bag is sealed, which assists in providing a better shelf-life of the product since there is relatively no air in the bag. The portion of the bag between the tail end of the bird and the seal is termed the “tail” of the bag, and the tail is preferably approximately at least 2.00 inches to provide additional bag material ensuring that at least 1.50 inches remain between the bag and the top and the sides of the bird. In other words, the placement of the seal on the tail of the bag relative to the bird is important to provide preferably approximately at least 1.50 inches between the bag and the bird on the top and the sides of the bird. The at least 1.50 inches between the bag and the bird allows the bag to sufficiently balloon away from the surface of the bird during cooking. If the seal is too close to the bird, the bag will not be allowed to sufficiently balloon away from the bird during cooking and the bird will over-cook and burn where the bag is in contact with the bird.

Preferred bag sizes for different sizes of birds are as follows in Table 1:

TABLE 1
Preferred Bird and Bag Specifications

| | Approximate | |
|---|---|---|
| | Bird Dimensions | Bag Dimensions |
| Bird Size | Length × Width × Depth | Width × Length |
| (Pounds) | (Inches) | (Inches) |
| 5 to 7 | 14 × 9 × 4 | 18 × 24 |
| 11 to 13 | 14 × 9 × 8 | 18 × 24 |
| 17 to 19 | 17 × 11 × 9 | 20 × 26 |

The preferred bag sizes for several weight ranges of birds were determined based upon the following data. The dimensions for birds weighing 11 to 13 pounds ranged from 13.000 to 14.125 inches long, 8.750 to 9.375 inches wide, and 7.250 to 7.500 inches deep. The dimensions for birds weighing 17 to 19 pounds ranged from 16.500 to 16.750 inches long, 10.625 to 11.240 inches wide, and 8.125 to 8.375 inches deep. These dimensions are listed as approximate dimensions in Table 1.

Based upon the above-listed bird dimensions, the following calculations were used to determine the preferred bag sizes:

The average diameter of the birds weighing 11 to 13 pounds was 8.20 inches. To ensure a 1.50 inches spacing around the top and the sides of the bird, the circumference of the bag would require 11.20 inches (8.20 inches+2×1.50 inches)×3.14=35.20 inches of material. A bag 18.00 inches wide will supply 36.00 inches of material, which is sufficient. A bag 24.00 inches long was found sufficient for clipping or sealing the bag, leaving a tail of approximately 2.00 inches, and allowing the bag to sufficiently balloon away from the bird.

The average diameter of the birds weighing 17 to 19 pounds was 9.60 inches. To ensure a 1.50 inches spacing around the top and the sides of the bird, the circumference of the bag would require 12.60 inches (9.60 inches+2×1.50 inches)×3.14=39.60 inches of material. A bag 20.00 inches wide will supply 40.00 of material, which is sufficient. A bag 26.00 inches long was found sufficient for clipping or sealing the bag, leaving a tail of approximately 2.00 inches, and allowing the bag to sufficiently balloon away from the bird.

For a bird weighing 14 pounds, a bag 18.00 inches wide and 23.00 inches long should preferably be used. For a bird weighing 20 pounds, a bag 20.00 inches wide and 26.00 inches long should preferably be used.

The results of numerous cooking tests of frozen whole birds indicated whenever the roasting bag was in contact with the bird when cooking, the product at the contact point over-cooked and became hard and crusty. When cooked in an oven, it is speculated that this is due to the dry heat transfer of the oven set point (350° F.) being in more direct contact with the bird during a substantial amount of time as opposed to the steam affect of the environment (around approximately 212° F. or so) between the bird and the bag when there is a space between the bird and the bag. The steam environment and the cooked-out juices at the bottom of the bag insulate the bird from the heat of the cooking device. A spacing of approximately 1.5 inches between the bird and the bag was targeted to ensure there was limited contact between the bird and the bag during cooking.

The bag is preferably made of a heat resistant, high tensile strength nylon blend such as a FLEXPAK product such as KENYLON protective packaging manufactured by KNF Corporation of Tamaqua, Pa. The bag enables a frozen whole turkey to be cooked without first defrosting the bird. The bird is preferably pre-seasoned and injected with a basting solution before it is placed in the bag, sealed, and frozen. The seasoning may be a rub and/or a marinade. Therefore, the consumer only simply needs to remove the bird from the freezer and place it in the cooking device, leaving the bird in the bag. The consumer may pierce or cut slits in the bag prior to placing it in the cooking device to assist in allowing the bird to brown during cooking. Preferably, the bird is placed in the cooking device with the breast portion of the bird facing upward. As the bird is cooking, the bag balloons away from the bird as a steam environment is created within the cavity of the bag, between the bird and the bag. Steam is proximate the outer surface of the bird and the inner cavity of the bird to cook the bird evenly and thoroughly. Evenly means that most areas of the bird are brought to approximately the same temperature. In other words, the meat proximate the outside surface of the bird and the meat proximate the center of the bird are cooked sufficiently to be safely eaten without overcooking any portion(s) of the bird. The steam environment in the bag thaws the bird rapidly and allows the bird to cook relatively uniformly without over-cooking the outside surface of the bird and ensuring the center of the bird is done. If cooked in an oven, the oven should be pre-heated to 350° F., and the frozen bird should be cooked for approximately 18 to 20 minutes per pound at approximately 350° F. It is recognized that the bird may also be cooked in a microwave oven. For example, for a bird weighing approximately 11 pounds, the bird may be cooked in less than 2 hours in a GENERAL ELECTRIC microwave oven Model #JE2160BF001 by General Electric Company of New York, N.Y. with a 1.65 KW power source on the high setting.

Cooking the frozen whole turkey in the heat resistant bag creates a steam environment within the bag, which contains the juices and the moisture from the bird as it cooks. As the frozen whole turkey cooks, the turkey thaws and the moisture creates steam within the bag. The steam places pressure on the bag causing the bag to extend outward from the bird. The steam environment, which is preferably approximately at least 1.50 inches around the top and the sides of the bird, and the cooked-out juices collected at the bottom of the bag prevent over-cooking and burning of the meat. The core temperature of 170° F. in the breast meat and 180° F. in the thigh meat is reached within a reasonable amount of time thereby cooking the whole turkey in a reasonable amount of time relative to a whole turkey that has been defrosted prior to cooking.

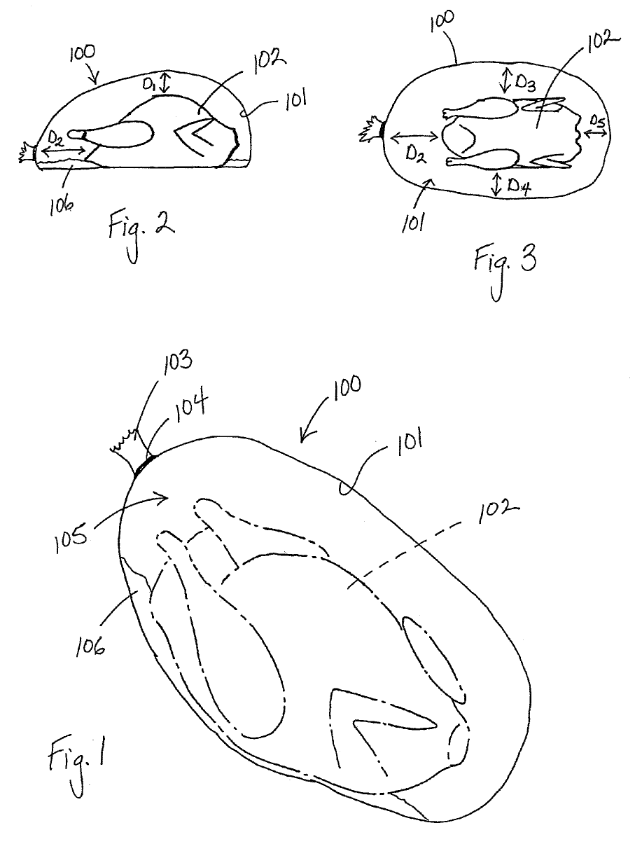

As shown in FIGS. 1-3, the bag 100 extends outward from the bird 102 during cooking thereby providing space 101 between the bag 100 and the bird 102. The open end 103 of the bag 100 is sealed with a clip 104 proximate the tail end 105 of the bird 102. The juices 106 from the bird 102 collect proximate the bottom of the bird 102 as it cooks. As shown in FIG. 2, distance D₁ is the distance between the turkey breast and the top of the bag 100 and is preferably at least 1.50 inches, and distance D₂ is the distance between the tail end of the bird 102 and the tail of the bag 100 and is preferably at least 2.00 inches. As shown in FIG. 3, D₃ is the distance between the right side of the turkey and the side of the bag 100, D₄ is the distance between the left side of the turkey and the side of the bag 100, and D₅ is the distance between the neck area of the turkey and the bag 100. Distances D₃, D₄, and D₅ are preferably at least 1.50 inches.

Cooking the bird in the bag, without having to remove the bird from the bag, helps prevent cross contamination. Also, not having to defrost the frozen bird or allow the frozen bird to thaw prior to cooking the bird helps prevent cross contamination and helps reduce the risk of spoilage.

### Example 1

An oven was preheated to 350° F., and a bag containing a frozen split turkey weighing approximately 5 to 7 pounds was placed breast side up in a roasting pan at least 2 inches deep. Six ½ inch long slits were cut proximate the top of the bag, and the bag was pulled upward and away from the bird to release the vacuum inside the bag. The bird was placed in the oven, allowing room for the bag to expand during cooking without contacting the oven walls or the oven racks. The bird was roasted until a meat thermometer reached 170° F. in the breast meat and 180° F. in the thigh meat. The cook time was approximately 2 to 2.5 hours from the frozen state of the split turkey.

### Example 2

An oven was preheated to 350° F., and a bag containing a frozen whole turkey weighing approximately 11 to 13 pounds was placed breast side up in a roasting pan at least 2 inches deep. Six ½ inch long slits were cut proximate the top of the bag, and the bag was pulled upward and away from the bird to release the vacuum inside the bag. The bird was placed in the oven, allowing room for the bag to expand during cooking without contacting the oven walls or the oven racks. The bird was roasted until a meat thermometer reached 170° F. in the breast meat and 180° F. in the thigh meat. The cook time was approximately 3.5 to 4 hours from the frozen state of the whole turkey.

### Example 3

A bag containing a frozen split turkey weighing approximately 5 to 7 pounds was obtained, and a ½ inch slit was cut in the bag proximate the clip sealing the bag for venting. The bird was placed breast side down in a microwave oven and cooked on high for 40 minutes. The bird was then turned over so the breast side was up (the cavity side of the bird was down) and cooked on high for 30 minutes. The temperature of the bird was checked to ensure the breast meat was 170° F. and the thigh meat was 180° F. Additional cooking for 5 minute intervals may be used until these desired temperatures are reached.

### Example 4

A bag containing a frozen whole turkey weighing approximately 11 to 13 pounds was obtained and placed breast side down in a microwave oven. The bird was cooked on high for 40 minutes and then turned over so the breast side was up (the back of the bird was down). Approximately four to six ½ inch slits were cut in the bag proximate the top of the bag for venting. The bird was cooked on high for 40 minutes and then cooked for an additional 20 minutes on high. The temperature of the bird was checked to ensure the breast meat was 170° F. and the thigh meat was 180° F. Additional cooking for 5 minute intervals may be used until these desired temperatures are reached.

### Example 5

A frozen bone-in turkey breast in an over-sized bag, Product A, was compared to a frozen bone-in turkey breast in a bag shrunk to fit the turkey breast, Product B. The over-sized bag had dimensions 18 inches wide and 24 inches long, and the frozen bone-in turkey breast in the sealed over-sized bag, Product A, weighed approximately 7.80 pounds. Product A was injected up to 15%. The frozen bone-in turkey breast in the bag shrunk to fit the turkey breast, Product B, weighed approximately 8.03 pounds and was a Roast-In-Its-Own-Bag turkey breast, Product Code #46903, manufactured by Carolina Turkey of Mt. Olive, N.C. Product B was injected up to 15%.

Products A and B were cooked at 350° F. in the same oven at the same time and rotated after 2.00 hours to decrease variation in heat exposure between the two products. The temperatures of the turkey breast meat of Products A and B were compared during the cooking of the turkey breast meat, and the results are as follows in Table 2:

TABLE 2
Turkey Breast Meat Temperature During Cooking

| Cooking Time | Temperature of Product A | Temperature of Product B |
|---|---|---|
| (Hours) | (° F.) | (° F.) |
| 2.00 | 109.9 | 27.4 |
| 3.00 | 160.0 | 120.0 |
| 3.50 | 176.0 | |
| 3.75 | | 169.0 |

Product A was done in 3.50 hours and yielded 5.35 pounds of meat, which was a 68.58% yield. Product A had a nice brown, roasted color and a nice appearance. The product was easy to remove from the bag and the turkey meat was very moist. Juices cooked-out of the turkey meat and were contained in the bag for use in making gravy. Product A sat upright so the turkey breast was displayed nicely. Product A cooked at approximately 25 to 30 minutes per pound.

Product B was done in 3.75 hours and yielded 5.52 pounds of meat, which was a 68.74% yield. The skin peeled off the turkey meat when removed from the bag, and there was a large amount of protein cook-out in the cavity of the turkey breast. Product B had a nice brown, roasted color where the skin had not peeled off the turkey meat. Juices cooked out of the product evaporated in the oven and were not contained in the bag for making gravy. Product B did not sit upright and laid to one side. Product B cooked at approximately 28 to 33 minutes per pound.

### Example 6

A frozen bone-in turkey breast in an over-sized bag, Product C, was compared to a frozen bone-in turkey breast in a bag shrunk to fit the turkey breast and thigh, Product D. The over-sized bag had dimensions 18 inches wide and 24 inches long, and the frozen bone-in turkey breast in the sealed over-sized bag, Product C, weighed approximately 6.61 pounds. Product C was injected up to 15%. The frozen bone-in turkey breast in the bag shrunk to fit the turkey breast and thigh, Product D, weighed approximately 7.11 pounds and was a Roast-In-Its-Own-Bag turkey breast and thigh, Product Code #46903, manufactured by Carolina Turkey of Mt. Olive, N.C. Product D was injected up to 15%.

Products C and D were cooked at 350° F. in the same oven at the same time and rotated after 2.00 hours to decrease variation in heat exposure between the two products. The temperatures of the turkey meat of Products C and D were compared during the cooking of the turkey meat, and the results are as follows in Table 3:

TABLE 3
Turkey Breast Meat Temperature During Cooking

| Cooking Time | Temperature of Product C | Temperature of Product D |
|---|---|---|
| (Hours) | (° F.) | (° F.) |
| 2.00 | 63.2 | 30.1 |
| 3.00 | 190.0 | 115.0 |
| 3.50 | | 150.0 |
| 3.75 | | 165.0 |

Product C was done in 3.00 hours and yielded 4.43 pounds of meat, which was a 67.02% yield. Product C had a nice brown, roasted color and a nice appearance. The product was easy to remove from the bag and the turkey meat was very moist. Juices cooked-out of the turkey meat and were contained in the bag for use in making gravy. Product C sat upright so the turkey breast was displayed nicely. Product C cooked at approximately 25 to 30 minutes per pound.

Product D was done in 3.75 hours and yielded 4.50 pounds of meat, which was a 63.29% yield. The skin peeled off the turkey meat when removed from the bag, and there was a large amount of protein cook-out in the cavity of the turkey breast. Product D had a nice brown, roasted color where the skin had not peeled off the turkey meat. Juices cooked out of the product evaporated in the oven and were not contained in the bag for making gravy. Product D did not sit upright and laid to one side. Product D cooked at approximately 28 to 33 minutes per pound.

The products used in Examples 5 and 6 were compared. The product produced by Carolina Turkey (Products B and D) is processed in a bag, which is shrunk tight around the product. The bag is designed to self-vent at the seal at the proper time. As a result, the juices evaporate during cooking and are not available for making gravy when the product is done cooking. In addition to the juices evaporating, the protein that cooks out of the product is concentrated in the cavity area and appears unsightly. A fair amount of the skin sticks to the bag and is pulled away from the product.

The product of the present invention (Products A and C) retains the juices in the bag and disperses the protein cook out so the protein is not as evident. The juices are available for making gravy when the product is done cooking. The cook time of the product of the present invention is slightly faster per pound (25 to 30 minutes per pound) than the Carolina Turkey product (28 to 33 minutes per pound). The product of the present invention allows for the product surface to brown without having the skin stick to the bag and pull away from the product.

### Example 7

A frozen turkey breast roast in an over-sized bag, Product E, was compared to a frozen turkey breast and thigh roast in a bag shrunk to fit the turkey breast and thigh, Product F. The over-sized bag had dimensions 18 inches wide and 24 inches long, and the frozen turkey breast roast in the sealed over-sized bag, Product E, weighed approximately 3.48 pounds. Product E was injected up to 12%. The frozen turkey breast and thigh roast in the bag shrunk to fit the turkey breast and thigh, Product F, weighed approximately 3.53 pounds and was a Roast-In-Its-Own-Bag turkey breast and thigh, Product Code #70077, manufactured by Carolina Turkey of Mt. Olive, North Carolina. Product F was injected up to 20%.

Products E and F were cooked at 350° F. in the same oven at the same time and rotated after 2.00 hours to decrease variation in heat exposure between the two products. The temperatures of the turkey meat of Products E and F were compared during the cooking of the turkey meat, and the results are as follows in Table 4:

TABLE 4
Turkey Meat Temperature During Cooking

| Cooking Time | Temperature of Product E | Temperature of Product F |
|---|---|---|
| (Hours) | (° F.) | (° F.) |
| 2.00 | 100.7 | 27.6 |
| 2.50 | 176.0 | 98.3 |
| 3.00 | | 146.0 |
| 3.50 | | 164.0 |

Product E was done in 2.50 hours and yielded 2.24 pounds of meat, which was a 64.36% yield. Product E had a nice brown, roasted color and a nice appearance. The product was easy to remove from the bag and the turkey meat was very moist. Juices cooked-out of the turkey meat and were contained in the bag for use in making gravy. Product E had a natural shape. Product E cooked at approximately 40 to 45 minutes per pound.

Product F was done in 3.50 hours and yielded 2.25 pounds of meat, which was a 63.73% yield. Product F stuck to the bag and was difficult to remove from the bag. Product F was not browned and had a very white appearance, a boiled appearance. The protein cook-out was on the top of the meat and was not very appealing. Juices cooked out of the product evaporated in the oven and were not contained in the bag for making gravy. Although Product F was injected at a higher percentage, the meat seemed drier than Product E. Product F cooked at approximately 55 to 60 minutes per pound.

### Example 8

A frozen turkey breast roast in an over-sized bag, Product G, was compared to a frozen turkey breast and thigh roast in a bag shrunk to fit the turkey breast and thigh, Product H. The over-sized bag had dimensions 18 inches wide and 24 inches long, and the frozen turkey breast roast in the sealed over-sized bag, Product G, weighed approximately 3.49 pounds. Product G was injected up to 12%. The frozen turkey breast and thigh roast in the bag shrunk to fit the turkey breast and thigh, Product H, weighed approximately 3.50 pounds and was a Roast-In-Its-Own-Bag turkey breast and thigh, Product Code #70077, manufactured by Carolina Turkey of Mt. Olive, N.C. Product F was injected up to 20%.

Products G and H were cooked at 350° F. in the same oven at the same time and rotated after 2.00 hours to decrease variation in heat exposure between the two products. The temperatures of the turkey meat of Products G and H were compared during the cooking of the turkey meat, and the results are as follows in Table 5:

TABLE 5
Turkey Meat Temperature During Cooking

| Cooking Time | Temperature of Product G | Temperature of Product H |
|---|---|---|
| (Hours) | (° F.) | (° F.) |
| 1.50 | 67.1 | 28.1 |
| 2.00 | 135.0 | 30.6 |
| 2.50 | 185.0 | 100.1 |
| 3.00 | | 148.0 |
| 3.25 | | 165.0 |

Product G was done in 2.50 hours and yielded 2.23 pounds of meat, which was a 63.89% yield. Product G had a nice brown, roasted color and a nice appearance. The product was easy to remove from the bag and the turkey meat was very moist. Juices cooked-out of the turkey meat and were contained in the bag for use in making gravy. Product G had a natural shape. Product G cooked at approximately 40 to 45 minutes per pound.

Product H was done in 3.25 hours and yielded 2.16 pounds of meat, which was a 61.71% yield. Product H stuck to the bag and was difficult to remove from the bag. Product H was not browned and had a very white appearance, a boiled appearance. The protein cook-out was on the top of the meat and was not very appealing. Juices cooked out of the product evaporated in the oven and were not contained in the bag for making gravy. Although Product H was injected at a higher percentage, the meat seemed drier than Product G. Product H cooked at approximately 55 to 60 minutes per pound.

The products used in Examples 7 and 8 were compared. The product produced by Carolina Turkey (Products F and H) is processed in a bag, which is shrunk tight around the product. The bag is designed to self-vent at the seal at the proper time. As a result, the juices evaporate during cooking and are not available for making gravy when the product is done cooking. In addition to the juices evaporating out of the bag, the protein that cooks out of the product is concentrated on the surface of the product and appears unsightly. A fair amount of the skin sticks to the bag and is pulled away from the product.

The product of the present invention (Products E and G) retains the juices in the bag and disperses the protein cook out so the protein is not as evident. The juices are available for making gravy when the product is done cooking. The cook time of the product of the present invention is considerably faster per pound (40 to 45 minutes per pound) than the Carolina Turkey product (55 to 60 minutes per pound). The product of the present invention allows for the product surface to brown without having the skin stick to the bag and pull away from the product.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of cooking frozen meat comprising:
placing meat in a bag, the meat having a top and sides, the meat being a size and being selected from the group consisting of a frozen whole turkey, a frozen split bird, a frozen breast, a frozen breast roast, a frozen pork roast, and a frozen beef roast, the meat being at least 3.48 pounds, the bag being over-sized relative to the meat and allowing space to be created between the bag and the top and the sides of the meat;
sealing the bag;
freezing the meat;
taking the meat out of a freezer;
piercing the bag;
pulling the bag away from the meat to release a vacuum inside the bag; and
cooking the frozen meat being the size within the bag, the over-sized bag being configured and arranged to create a sufficient steam environment within the bag proximate the top and the sides of the frozen meat to thaw the meat and cook the meat evenly, wherein juices cook-out of the meat during cooking and collect at a bottom of the bag to assist in thawing and cooking the meat evenly.

2. The method of claim 1, wherein the bag is pierced prior to cooking the frozen meat thereby allowing steam to escape during cooking of the meat.

3. The method of claim 1, wherein the space between the bag and the top and the sides of the meat is approximately at least 1.50 inches during cooking when the steam environment is created.

4. The method of claim 1, wherein the meat is a whole turkey.

5. The method of claim 4, wherein the whole turkey is cooked in a microwave oven on high for at least 40 minutes and then turned over and cooked on high for at least 30 minutes.

6. The method of claim 4, wherein the whole turkey is cooked in an oven for 18 to 20 minutes per pound at approximately 350° F.

7. The method of claim 1, wherein the bag is pierced after an initial cooking time period thereby allowing steam to escape during a remaining cooking time period of the meat.

8. The method of claim 7, wherein the bag is pierced after an initial cooking time period thereby allowing steam to escape during a remaining cooking time period of the bird.

9. A method of cooking a frozen whole bird, the whole bird having a top and sides, the whole bird being placed in an over-sized bag relative to the whole bird, the over-sized bag allowing space to be created between the over-sized bag and the top and the sides of the whole bird, the whole bird being frozen within the over-sized bag, comprising:
taking the frozen whole bird out of a freezer;
piercing the bag;
pulling the bag away from the frozen whole bird to release a vacuum inside the bag; and
cooking the frozen whole bird in the over-sized bag, the over-sized bag being configured and arranged to create a sufficient steam environment within the bag proximate the top and the sides of the frozen whole bird to cook the whole bird evenly.

10. The method of claim 9, wherein the whole bird is a whole turkey.

11. The method of claim 9, wherein the bag is pierced prior to cooking the frozen whole bird thereby allowing steam to escape during cooking.

12. The method of claim 9, wherein the space between the bag and the top and the sides of the frozen whole bird is approximately at least 1.50 inches during cooking when the steam environment is created.

13. The method of claim 9, wherein juices cook-out of the frozen whole bird during cooking and collect at the bottom of the bag to assist in cooking the whole bird evenly.

14. The method of claim 9, wherein the frozen whole bird is cooked in a microwave oven on high for at least 40 minutes and then turned over and cooked on high for at least 30 minutes.

15. The method of claim 9, wherein the frozen whole bird is cooked in an oven for 18 to 20 minutes per pound at approximately 350° F.

16. A method of cooking a frozen whole turkey, the whole turkey having a top and sides, comprising:
placing the whole turkey in a bag, the bag being over-sized relative to the whole turkey and allowing space to be created between the bag and the top and the sides of the whole turkey;
freezing the whole turkey;
taking the frozen whole turkey out of a freezer;
piercing the bag;
pulling the bag away from the frozen whole turkey to release a vacuum inside the bag; and
cooking the frozen whole turkey, the over-sized bag being configured and arranged to create a sufficient steam environment within the bag proximate the top and the sides of the whole turkey to cook the whole turkey evenly.

17. The method of claim 16, wherein the bag is pierced prior to cooking the frozen whole turkey thereby allowing steam to escape during cooking.

18. The method of claim 16, wherein the space between the bag and the top and the sides of the whole turkey is approximately at least 1.50 inches during cooking when the steam environment is created.

19. The method of claim 16, wherein juices cook-out of the whole turkey during cooking and collect at the bottom of the bag to assist in cooking the whole turkey evenly.

20. The method of claim 16, wherein the frozen whole turkey is cooked in a microwave oven on high for at least 40 minutes and then turned over and cooked on high for at least 30 minutes.

21. The method of claim 16, wherein the frozen whole turkey is cooked in an oven for 18 to 20 minutes per pound at approximately 350° F.

22. The method of claim 16, wherein the bag is pierced after an initial cooking time period thereby allowing steam to escape during a remaining cooking time period of the whole turkey.
